(19) United States
(12) Patent Application Publication
(10) Pub. No.: US 2010/0108342 A1
(43) Pub. Date: May 6, 2010

(54) LAYERED STRUCTURE WITH OUTER LIGHTNING PROTECTION SURFACE

(75) Inventors: Harry Shimp, Chagrin Falls, OH (US); Kenneth Mull, Woodbridge, CT (US)

Correspondence Address: CALFEE HALTER & GRISWOLD, LLP, 800 SUPERIOR AVENUE, SUITE 1400, CLEVELAND, OH, 44114, US

(73) Assignee: DEXMET CORPORATION, Wallingford, CT (US)

(21) Appl. No.: 12/262,361

(22) Filed: Oct. 31, 2008

(51) Int. Cl. H02G 13/00; B29C 65/00

(52) U.S. Cl. 174/2; 156/60

(57) ABSTRACT

An improved layered structure with an outer lightning protection surface is provided. The layered structure may include an expanded metal foil processed to reduce the number, severity, or the number and severity of stress concentration sites, thereby reducing micro-crack initiation sites. Chemical etching, mechanical micro-deburring processes, or both may be used to address stress concentration sites on the expanded metal foil.

### BACKGROUND

The present application relates generally to the protection of structures that may be subjected to lightning. In particular, the application subject matter reduces the occurrence of micro-cracking in such structures when a sacrificial metal layer outer surface is used for lightning protection.

Many structures may need protection from lightning. For example, lightning protection is a requirement on many Fiber Reinforced Plastic (FRP) aerospace structures and other composite parts that may be subjected to lightning. While the FRP matrix may be conductive, the FRP structure may not disperse the highly concentrated energy from a lightning strike quickly enough to prevent delamination and embrittlement of the structure. A lightning strike on an unprotected FRP structure may thus result in complete failure, leaving a hole in the FRP structure.

Historically, one engineering approach to protecting FRP structures from lightning has been to include a thin layer of metal foil or screen in the outer layer of the composite. When struck by lightning, the metal layer is vaporized into a plasma ball which disburses the energy, thereby sacrificially protecting the FRP matrix underneath from severe damage. The metal outer surface layer may be solid foil, expanded foil, woven wire screen, wire interwoven into the FRP matrix, or have some other configuration.

The metals used in the sacrificial metal outer surface layer are selected for their ability to absorb energy, electrical conductivity, and chemical inertness relative to the graphite fibers or other components in the FRP. However, these metals may not have the same coefficient of expansion (COE) as the rest of the FRP structure. As the protected FRP structure undergoes changes in temperature during its lifetime, the COE difference between layers may result in independent movement between the sacrificial metal outer surface layer and the FRP matrix, inducing stresses that can lead to micro-cracking within the FRP structure. These micro-cracks can lead to discoloration and corrosion and may reduce the strength of the FRP structure, or lead to delamination and complete failure.

The COE difference between the sacrificial metal outer surface layer and the rest of the FRP structure is believed to be a driving force behind micro-cracking. However, the inventors herein believe (without being bound by that theory) that the existence of sharp edges or points on the metal foil may serve as stress concentration sites, which may initiate micro-cracking. A reduction in the number or severity of these stress concentration sites could greatly reduce or eliminate the degree of micro-cracking.

### SUMMARY

According to one aspect of the present invention, a layered structure is provided including an underlying structure to be protected from lightning and an electrically conductive outer surface layer attached to the underlying structure. The electrically conductive outer surface layer is subjected to a stress concentration site reducing operation.

According to a further aspect of the present invention, a method of making a layered structure is provided. An electrically conductive outer surface layer is formed, stress concentration sites on the electrically conductive outer surface layer are reduced, and the electrically conductive outer surface layer is combined with an underlying structure to be protected from lightning.

### BRIEF DESCRIPTION OF THE DRAWINGS

FIG. 1 is a cross section drawing of layers of an exemplary Fiber Reinforced Plastic (FRP) composite structure with an electrically conductive outer surface layer;

FIG. 2 is a drawing of an exemplary expanded metal foil, illustrating exemplary stress concentration sites;

FIG. 3 is a cross section drawing of a metal strand of an exemplary expanded metal foil, taken along line 3-3 in FIG. 2;

FIG. 4 is a cross section drawing of the metal strand of FIG. 3 interfaced with an FRP composite structure;

FIG. 5 is a cross section drawing of the metal strand of FIG. 3 immersed into an FRP composite structure;

FIG. 6 is a cross section drawing of a metal strand of an exemplary expanded metal foil in which the number or severity of stress concentration sites has been reduced; and

FIG. 7 is a cross section drawing of the metal strand of the exemplary expanded metal foil of FIG. 6 interfaced with an FRP composite structure.

### DESCRIPTION

An exemplary Fiber Reinforced Plastic (FRP) composite structure 100 is shown in FIG. 1. The composite structure 100 is shown with an FRP matrix layer 102 and an electrically conductive outer surface layer 104. The FRP matrix layer 102 is attached to the electrically conductive outer surface layer 104 at interface 106. The electrically conductive outer surface layer 104 protects the FRP matrix layer 102 from damage when the composite structure 100 is subjected to lightning 108.

The electrically conductive outer surface layer 104 may be produced from a metal. For example, the electrically conductive outer surface layer 104 may be in the form of a solid foil, an expanded foil, a woven wire screen, or a wire interwoven into the FRP matrix layer 102. Exemplary metals that may be used for the electrically conductive outer surface layer 104 include aluminum (and its alloys), copper (and its alloys such as brass and bronze), nickel (and its alloys such as monel), tantalum, stainless steel, niobium, and titanium. These and any other metals that may be used for the electrically conductive outer surface layer 104 may be passivated through processes such as anodization or other oxidization methods. Ideally, the outer surface layer 104 is made from a material or combination of materials that is chemically inert with respect to the underlying structure 102, has a relatively large heat of fusion and heat of vaporization, and a relatively low electrical resistance.

The electrically conductive outer surface layer 104 may alternatively be made from a non-metal, yet electrically conductive, material or combination of materials. For example, the electrically conductive outer surface layer 104 may be an expanded polymer plastic that has been coated with an external metal layer, for example, via plating or vapor deposition.

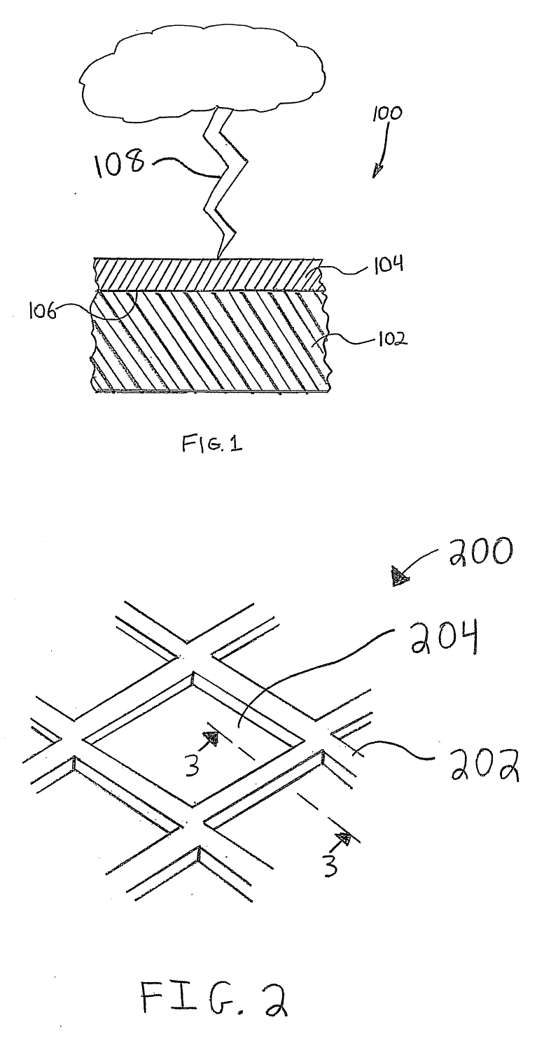

FIG. 2 is a drawing of an exemplary expanded metal foil 200 that can be used as the electrically conductive outer surface layer 104. The expanded metal foil 200 may have a lattice-like grid of metal strands 202 separated by openings 204. For example, as depicted in FIG. 2, the metal strands 202 may be configured with diamond-shaped openings 204. However, the expanded metal foil 200 may be configured with metal strands 202 and openings 204 of any shape and size suitable for a particular application.

The expanded metal foil 200 may be produced, for example, by a method of slit and stretch. In this manner, a precision die can slit and stretch the metal material in as little as one operation. The metal material can then be directed through a set of rollers to adjust the metal material to a final thickness for the expanded metal foil 200. The shape, form, and number of openings are dictated by the particular tool used and may be modified or changed to suit a particular application.

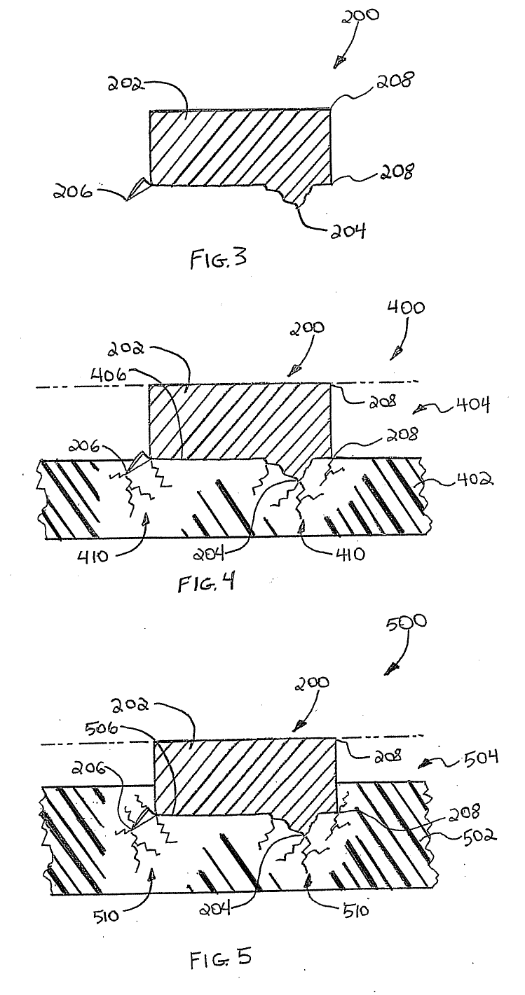

As with many metal forming operations, the resultant expanded metal foil 200 may have various burrs, chads, or sharp edges along the metal strands 202. In general, such stress concentration sites may be expected and accepted by the user of the finished part. These characteristics can vary in many ways, such as shape, size, number, location, and severity. FIG. 3 is a cross section drawing of a metal strand 202 in an exemplary expanded metal foil 200, taken along line 3-3 in FIG. 2, showing such stress concentration sites. For example, a burr 204 is shown extending from the surface of the metal strand 202; a chad 206 is shown hanging from the edge of the metal strand 202; and sharp edges 208 are shown on the edges of the metal strand 202. For illustration purposes, the burr 204 and chad 206 are drawn relatively large, but they may also be very small, and in many cases imperceptible without magnification. Although the exemplary stress concentration sites shown in FIG. 3 are along the sides of the metal strands 202, the burrs 204, chads 206, or sharp edges 208 may occur anywhere throughout the expanded metal foil 200, including on the relatively flat sides of the strands 202 and in the areas where two or more metal strands 202 intersect, forming corners in the grid.

As can be appreciated by referring to the cross section drawing of a composite structure 400 in FIG. 4, an electrically conductive outer surface layer 404 may be the expanded metal foil 200 with metal strands 202. It should be evident that the burrs 204, chads 206, sharp edges 208 and similar stress concentration sites along the metal strands 202 located at interface 406 will be in contact with an FRP matrix layer 402. FIG. 4 shows the composite structure 400 with the electrically conductive outer surface layer 404 and the FRP matrix layer 402 interfacing along a line at the interface 406.

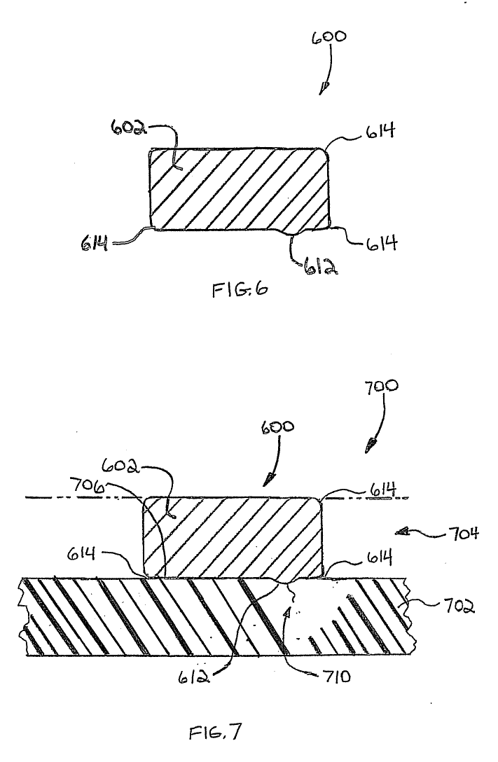

Alternatively, as shown for example in FIG. 5, a composite structure 500 may include an electrically conductive outer surface layer 504, such as the expanded metal foil 200, interwoven or immersed into the surface of an FRP matrix layer 502. In this way, a portion or all of the expanded metal foil 200 may be disposed within the FRP matrix layer 502. This results in an interface 506 that at least partially surrounds the immersed metal strand 202 surfaces of the expanded metal foil 200.

As the composite structure 400 or 500 undergoes changes in temperature during its lifetime, any coefficient of expansion (COE) difference between the electrically conductive outer surface layer 404, 504 and the FRP matrix layer 402, 502 could result in independent movement and stress at the interface 406, 506, potentially resulting in micro-cracking within the composite structure 400, 500, and in particular, the FRP matrix layer 402, 502. Burrs 204, chads 206, sharp edges 208 and similar stress concentration sites on the metal strands 202 of the expanded metal foil 200 serve as stress concentration sites for micro-cracks 410, 510. For illustration purposes, the micro-cracks 410, 510 are drawn relatively large, but they may be very small, and in many cases may be imperceptible without magnification. The micro-cracks 410, 510 are also drawn originating from the tips of the burr 204, chad 206, or sharp edge 208. However, the micro-cracks 410, 510 can originate from any area where burrs 204, chads 206, sharp edges 208 or similar stress concentration sites make contact with the FRP matrix layer 402, 502. In some cases, a micro-crack 410, 510 can start in the area around the burr 204, chad 206, or sharp edge 208, but not originate directly from the surface of the burr 204, chad 206, or sharp edge 208. Consequently, any burrs 204, chads 206, sharp edges 208 or the like occurring within the interface 406, 506 area are potential initiation sites for micro-cracking 410, 510.

A reduction in the number or severity of these stress concentration sites may greatly reduce the degree and severity of micro-cracking 410, 510. Once initiated, micro-cracks 410, 510 typically propagate further when exposed to additional expansion and contraction stress, vibration, other materials, or other stresses.

Burrs 204, chads 206, sharp edges 208 and similar stress concentration sites on the expanded metal foil 200 may be reduced and their effects neutralized by post expansion processing. Such processing may reduce either the number, or severity, or both, of the stress concentration sites. Chemical and electrochemical etching are exemplary methods of post expansion processing of the expanded metal foil 200. Other potential post expansion processing methods include mechanical micro-deburring. FIG. 6 shows a metal strand 602 of a processed expanded metal foil 600. For example, the processed metal strand 602 in FIG. 6, when compared to the unprocessed metal strand 202 of FIG. 3, shows the effects of post expansion processing on the expanded metal foil 600. In particular, the burr 204 is processed into a rounded hump 612, the chad 206 is removed and replaced with a dull edge 614, and the sharp edges 208 have also been processed into dull edges 614.

FIG. 7 shows a composite structure 700 with an electrically conductive outer surface layer 704 and an FRP matrix layer 702 interfacing along a line at interface 706. The composite structure 700 is shown with the metal strand 602 of the processed expanded metal foil 600 from FIG. 6 as the electrically conductive outer surface layer 704. For example, the processed metal strand 602 in FIG. 7, when compared to the unprocessed metal strand 202 of FIG. 4, shows the effects of post expansion processing on the composite structure 700: a reduction in the number and severity of the stress concentration sites, thus reducing or eliminating micro-cracks 710.

Chemical etching may be done using a variety of chemical or electrochemical processes that preferentially free or remove material from burrs 204, free chads 206, and remove material from sharp edges 208 of the expanded metal foil 200. Mechanical micro-deburring may remove burrs 204 and chads 206 and dull the sharp edges 208 of the expanded metal foil 200 without changing the general shape of the expanded metal foil 200. These processes result in a reduction in the number and severity of stress concentration sites on the expanded metal foil 200 and, consequently, reduce the likelihood of micro-crack initiation sites forming within the composite structure 100, 400, 500, 700.

Although embodiments of the invention have been shown and described, it is understood that equivalents and modifications will occur to others in the art upon the reading and understanding of the specification. The present invention includes all such equivalents and modifications.

We claim:

1. A layered structure, comprising an underlying structure to be protected from lightning and an electrically conductive outer surface layer attached to the underlying structure, wherein the electrically conductive outer surface layer has been subjected to a stress concentration site reducing operation and the electrically conductive outer surface layer is produced from a material selected from the group consisting of copper, copper alloys, nickel, nickel alloys, tantalum, stainless steel, niobium, and titanium.

2. The layered structure of claim 1, wherein the electrically conductive outer surface layer is an expanded metal foil.

3. The layered structure of claim 2, wherein the stress concentration site reducing operation comprises a mechanical process.

4. The layered structure of claim 2, wherein the stress concentration site reducing operation comprises a chemical or electrochemical process.

5. The layered structure of claim 1, wherein a coefficient of expansion of the underlying structure is different from a coefficient of expansion of the outer surface layer.

6. The layered structure of claim 1, wherein the electrically conductive outer surface layer is at least partially immersed in the underlying structure.

7. The layered structure of claim 1, wherein the underlying structure is a Fiber Reinforced Plastic (FRP) matrix layer.

8. A layered structure, comprising an underlying structure to be protected from lightning and an electrically conductive outer surface layer attached to the underlying structure, wherein the electrically conductive outer surface layer has been subjected to a stress concentration site reducing operation and the electrically conductive outer surface layer is an expanded polymer plastic that has been coated with an external metal layer.

9. A method of making a layered structure, comprising the steps of:
forming an electrically conductive outer surface layer;
reducing stress concentration sites on the electrically conductive outer surface layer; and
combining the electrically conductive outer surface layer with an underlying structure to be protected from lightning;
wherein the electrically conductive outer surface layer is produced from a material selected from the group consisting of copper, copper alloys, nickel, nickel alloys, tantalum, stainless steel, niobium, and titanium.

10. The method of claim 9, wherein the electrically conductive outer surface layer is an expanded metal foil.

11. The method of claim 10, wherein the step of reducing stress concentration sites comprises a mechanical process.

12. The method of claim 10, wherein the step of reducing stress concentration sites comprises a chemical or an electrochemical process.

13. The method of claim 9, wherein a coefficient of expansion of the underlying structure is different from a coefficient of expansion of the outer surface layer.

14. The method of claim 9, wherein the electrically conductive outer surface layer is at least partially immersed in the underlying structure.

15. The method of claim 9, wherein the underlying structure is a Fiber Reinforced Plastic (FRP) matrix layer.

16. A method of making a layered structure, comprising the steps of:
forming an electrically conductive outer surface layer from a passivated aluminum or a passivated aluminum alloy;
reducing stress concentration sites on the electrically conductive outer surface layer; and
combining the electrically conductive outer surface layer with an underlying structure to be protected from lightning.

17. The method of claim 16, wherein the electrically conductive outer surface layer is an expanded metal foil.

18. The method of claim 16, wherein the stress concentration site reducing operation comprises a mechanical process, a chemical process, or an electrochemical process.

19. The method of claim 16, wherein the electrically conductive outer surface layer is at least partially immersed in the underlying structure.

20. The method of claim 16, wherein the underlying structure is a Fiber Reinforced Plastic (FRP) matrix layer.
